(19) United States
(12) Patent Application Publication
(10) Pub. No.: US 2026/0236663 A1
(43) Pub. Date: Aug. 13, 2026

(54) METHOD AND APPARATUS WITH TWO-DIMENSIONAL CELL PLACEMENT OPTIMIZATION

(71) Applicant: Samsung Electronics Co., Ltd., Suwon-si (KR)

(72) Inventors: Minjun KIM, Suwon-si (KR); Inho ROH, Suwon-si (KR); Hyung-Dal KWON, Suwon-si (KR); Kyunghwan SON, Suwon-si (KR); Bosun HWANG, Suwon-si (KR); Cheol-Hwan KIM, Suwon-si (KR); Se-Il OH, Suwon-si (KR); Woochang LEE, Suwon-si (KR)

(73) Assignee: Samsung Electronics Co., Ltd., Suwon-si (KR)

(21) Appl. No.: 19/464,838

(22) Filed: Jan. 30, 2026

(30) Foreign Application Priority Data
Feb. 7, 2025 (KR) 10-2025-0016106

(51) Int. Cl. G06F 30/398; G06F 30/392; G06F 30/3947; G06F 111/04; G06F 111/08; G06F 117/12

(52) U.S. Cl. CPC G06F 30/398; G06F 30/392; G06F 30/3947; G06F 2111/04; G06F 2111/08; G06F 2117/12

(57) ABSTRACT

An electronic apparatus including one or more processors including processing circuitry and a memory including one or more storage media storing instructions that, when executed individually or collectively by the one or more processors, cause the electronic apparatus to generate multiple sequences for multiple cells of a semiconductor circuit, generate multiple 2D placements for the multiple cells based on the generated sequences, evaluate a placement for each of the multiple 2D placement, and determine a final 2D placement among the 2D placements based on a result of the placement evaluation.

### CROSS-REFERENCE TO RELATED APPLICATION

This application claims priority to and the benefit of Korean Patent Application No. 10-2025-0016106 filed with the Korean Intellectual Property Office on February 7, 2025, the entire contents of which are incorporated herein by reference.

### BACKGROUND

### (a) Field

The present disclosure relates to a method and apparatus with two-dimensional cell placement optimization, and more specifically, to a two-dimensional cell placement optimization apparatus and method for solving an optimization problem of a semiconductor circuit design through an algorithm.

### (b) Description of the Related Art

In semiconductor circuit design, cell placement optimization determines placement of logic elements within a chip. Quality of the placement affects signal delay, power consumption, area efficiency, etc., so there is a desire to optimize these techniques.

Typical optimization methods include sequential placement, Monte Carlo search, force-directed placement, and the like.

Specifically, main goals of optimization may include minimizing wire length, balancing power consumption, and maintaining signal integrity. Currently, technologies such as ML-based predictive models, reinforcement learning, and metaheuristic techniques are being utilized to improve placement optimization.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided an electronic apparatus including one or more processors including processing circuitry and a memory including one or more storage media storing instructions that, when executed individually or collectively by the one or more processors, cause the electronic apparatus to generate multiple sequences for multiple cells of a semiconductor circuit, generate multiple 2D placements for the multiple cells based on the generated sequences, evaluate a placement for each of the multiple 2D placement, and determine a final 2D placement among the 2D placements based on a result of the placement evaluation.

The generating of the multiple sequences may include randomly generating the sequences without duplication.

The generating of the multiple sequences may include sequentially generating the multiple sequences using a local search algorithm based on a result of the placement evaluation.

The generating of the multiple sequences may also include generating the multiple sequences using a perturbation algorithm responsive to an occurrence of a local optima according to the local search algorithm.

The generating of the multiple 2D placements may include generating a plurality of 2D placements to satisfy a feasibility of the semiconductor circuit based on cell data for the cells.

The generating of the multiple 2D placements may include generating the 2D placements to satisfy predetermined constraints based on the cell data in relation to placements of the cells.

The cell data may include one or more of a two-dimensional shape of a cell, a position of a port within a cell, connection information of cells, power information of the cell, and flip information of the cell.

The generating of the multiple 2D placements may include generating 2D placements to minimize idle space according to 2D shapes of the multiple cells responsive to a satisfaction of both the feasibility and the predetermined constraints.

The evaluating may include measuring a wire length of the semiconductor circuit for the 2D placements and evaluating the placement based on the measured wire length.

The determining of the final 2D placement may include determining at least one placement to minimize the wiring length among the 2D placements as a final 2D placement by using a local search algorithm and a perturbation algorithm.

In a general aspect, here is provided a processor-implemented method including generating multiple sequences for multiple cells of a semiconductor circuit, generating multiple 2D placements for the multiple cells based on the generated sequences, evaluating a placement for each of the multiple 2D placement, and determining a final 2D placement among the 2D placements based on a result of the placement evaluation.

The generating of the multiple sequences may include randomly generating the multiple sequences without duplication.

The generating of the multiple sequences may include sequentially generating the multiple sequences using a local search algorithm based on a result of the placement evaluation.

The generating of the multiple sequences may also include generating the multiple sequences using a perturbation algorithm responsive to an occurrence of a local optima according to the local search algorithm.

The generating of the multiple 2D placements may include generating a plurality of 2D placements to satisfy a feasibility of the semiconductor circuit based on cell data for the cells.

The generating of the multiple 2D placements further may include generating the 2D placements to satisfy predetermined constraints based on the cell data in relation to placements of the cells.

The cell data may include one or more of a two-dimensional shape of a cell, a position of a port within a cell, connection information of cells, power information of the cell, and flip information of the cell.

The generating of the multiple 2D placements further may include generating 2D placements to minimize idle space according to 2D shapes of the multiple cells responsive to a satisfaction of both the feasibility and the predetermined constraints.

The evaluating may include measuring a wire length of the semiconductor circuit for the 2D placements and evaluating the placement based on the measured wire length.

The determining of the final 2D placement may include determining at least one placement to minimize the wiring length among the 2D placements as a final 2D placement by using a local search algorithm and a perturbation algorithm.

### BRIEF DESCRIPTION OF THE DRAWINGS

FIG. 1 illustrates an example electronic device with two-dimensional cell placement optimization according to one or more embodiments.

FIG. 2 illustrates an example method with two-dimensional cell placement optimization according to one or more embodiments.

FIG. 3 illustrates an example process with two-dimensional cell placement optimization according to one or more embodiments.

FIG. 4 illustrates an example process with two-dimensional cell placement optimization according to one or more embodiments.

FIG. 5 illustrates an example process with two-dimensional cell placement optimization according to one or more embodiments.

FIG. 6 illustrates an example electronic device according to one or more embodiments.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term "may" herein with respect to an example or embodiment (e.g., as to what an example or embodiment may include or implement) means that at least one example or embodiment exists where such a feature is included or implemented, while all examples are not limited thereto. The use of the terms "example", "embodiment", and "example embodiment" herein have a same meaning (e.g., the phrasing 'in an or one example' has a same meaning as 'in an or one embodiment" and 'in an or one example embodiment'), and "one or more examples" has a same meaning as "one or more embodiments" and "one or more example embodiments". Still further, each of multiple or all separately described an/one "example", "embodiment", "example embodiment", as well as "examples", "embodiments", "example embodiments", herein may be included, in combination, in a same embodiment in any combination.

Although terms such as "first," "second," and "third", or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles "a," "an," and "the" are intended to include the plural forms as well, unless the context clearly indicates otherwise. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms "comprise" or "comprises," "include" or "includes," and "have" or "has" specify the presence of stated features, numbers, operations, members, elements, and/or combinations thereof, other embodiments may exist where one or more of the stated features, numbers, operations, members, elements, and/or combinations thereof are not present.

As used in connection with various example embodiments of the disclosure, any use of the terms "module" or "unit" means hardware and/or processing hardware configured to implement software and/or firmware to configure such processing hardware to perform corresponding operations, and may interchangeably be used with other terms, for example, "logic," "logic block," "part," or "circuitry". As one non-limiting example, an application-predetermined integrated circuit (ASIC) may be referred to as an application-predetermined integrated module. As another non-limiting example, a field-programmable gate array (FPGA) or an application-specific integrated circuit (ASIC) may be respectively referred to as a field-programmable gate unit or an application-specific integrated unit. In a non-limiting example, such software may include components such as software components, object-oriented software components, class components, and may include processor task components, processes, functions, attributes, procedures, subroutines, segments of the software. Software may further include program code, drivers, firmware, microcode, circuits, data, database, data structures, tables, arrays, and variables. In another non-limiting example, such software may be executed by one or more central processing units (CPUs) of an electronic device or secure multimedia card.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

Embodiments of the present disclosure will now be described with reference to the accompanying drawings.

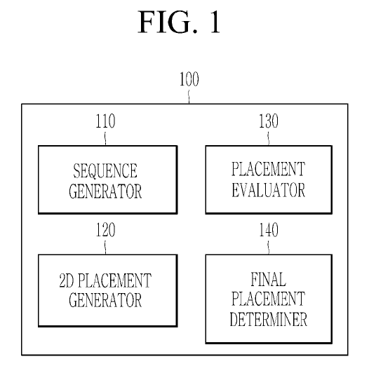

FIG. 1 illustrates an example electronic device with two-dimensional cell placement optimization according to one or more embodiments.

Referring to FIG. 1, in a non-limiting example, an electronic apparatus 100 with two-dimensional cell placement optimization apparatus may execute program codes or instructions loaded in one or more memory devices through one or more processors.

For example, the electronic apparatus 100 may be implemented as an electronic device 900 as described in greater detail below with reference to FIG. 6. In an example, one or more processors may correspond to a processor 910 of the computing device 900, and one or more memory devices may correspond to a memory 930 of the computing device 900.

The program codes or instructions may be executed by one or more processors to optimize two-dimensional cell placement in a semiconductor circuit design.

In an example, the electronic apparatus 100 with two-dimensional cell placement optimization may include a sequence generator110, a two-dimensional placement generator 120, a placement evaluator 130, and a final placement determiner 140.

In an example, the sequence generator 110 may generate multiple sequences for multiple cells.

The s sequence generator 110 may randomly generate multiple sequences without duplication. The multiple sequences may be sequentially generated using a local search algorithm. For example, the sequence generator 110 may sequentially generate the multiple sequences using the local search algorithm based on a result of placement evaluation for each of the multiple sequences. The sequences may be generated using a perturbation algorithm when a local optima occurs according to a local search algorithm.

The 2D placement generator 120 may generate multiple 2D placements for multiple cells based on the generated sequences.

The 2D placement generator 120 may generate the multiple placements that satisfy feasibility of a semiconductor circuit based on cell data for the multiple cells.

The 2D placement generator 120 may generate multiple two-dimensional placements related to arrangement of multiple cells, based on cell data, satisfying all predetermined constraints.

Herein, the cell data may include at least one of a two-dimensional shape of the cell, a position of a port within the cell, connection information of the cells, power information of the cell, and/or flip information of the cell considering power.

The 2D placement generator 120 may generate multiple two-dimensional placements that minimize idle space by considering the two-dimensional shapes of the multiple cells when satisfying the feasibility and all the aforementioned constraints.

The placement evaluator 130 may perform a placement evaluation for each of the multiple two-dimensional placements.

The placement evaluator 130 may measure the wire length of the semiconductor circuit for the multiple two-dimensional placements, and may perform a placement evaluation based on the measured wire length.

The final placement determiner 140 may determine a final two-dimensional placement among the multiple two-dimensional placements based on a result of the placement evaluation.

The final placement determiner 140 may utilize a local search algorithm and a perturbation algorithm to determine at least one placement among the multiple two-dimensional placements that minimizes the wire length as the final two-dimensional placement.

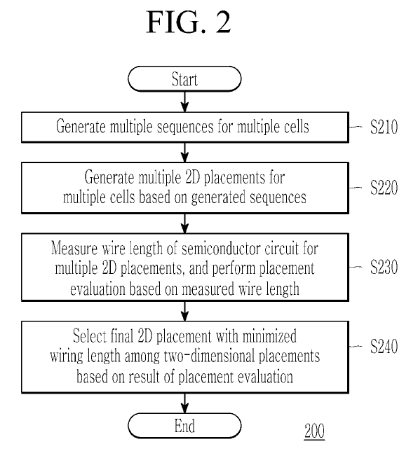

FIG. 2 illustrates an example method with two-dimensional cell placement optimization according to one or more embodiments. The two-dimensional cell placement optimization method may be performed through the two-dimensional cell placement optimization apparatus 100 of FIG. 1.

Referring to FIG. 2, in a non-limiting example, an electronic apparatus (e.g., electronic apparatus 100) may perform a method 200 with two-dimensional cell placement optimization including step S210 in which multiple sequences for multiple cells are generated.

The electronic apparatus may randomly generate the multiple sequences without duplication.

The electronic apparatus may sequentially generate the multiple sequences using the local search algorithm based on a result of placement evaluation for each of the multiple sequences.

The electronic apparatus may generate the sequences using a perturbation algorithm when a local optima occurs according to a local search algorithm.

In an example, an electronic apparatus with two-dimensional cell placement optimization (e.g., electronic apparatus 100) may generate multiple 2D placements for multiple cells based on the generated sequences in step S220.

The electronic apparatus may generate the multiple placements that satisfy feasibility of a semiconductor circuit based on cell data for the multiple cells.

The electronic apparatus may generate multiple two-dimensional placements related to arrangement of multiple cells, based on cell data, satisfying all predetermined constraints.

The cell data may include a two-dimensional shape of the cell, a position of a port within the cell, connection information of the cells, power information of the cell, and /or flip information of the cell considering power.

The electronic apparatus may generate multiple two-dimensional placements that minimize idle space by considering the two-dimensional shapes of the multiple cells when satisfying the feasibility and all the aforementioned constraints.

In an example, an electronic apparatus with two-dimensional cell placement optimization (e.g., electronic apparatus 100) may measure the wire length of the semiconductor circuit for the multiple two-dimensional placements, and may perform a placement evaluation based on the measured wire length in step S230.

The electronic apparatus 100 may measure the wire length of the semiconductor circuit for the multiple two-dimensional placements, and may perform the placement evaluation based on the measured wire length.

In an example an electronic apparatus with two-dimensional cell placement optimization (e.g., electronic apparatus 100) may select a final two-dimensional placement with a minimized wiring length among the two-dimensional placements based on a result of placement evaluation in step S240.

The electronic apparatus may utilize a local search algorithm and a perturbation algorithm to determine at least one placement among the multiple two-dimensional placements that minimizes the wire length as the final two-dimensional placement.

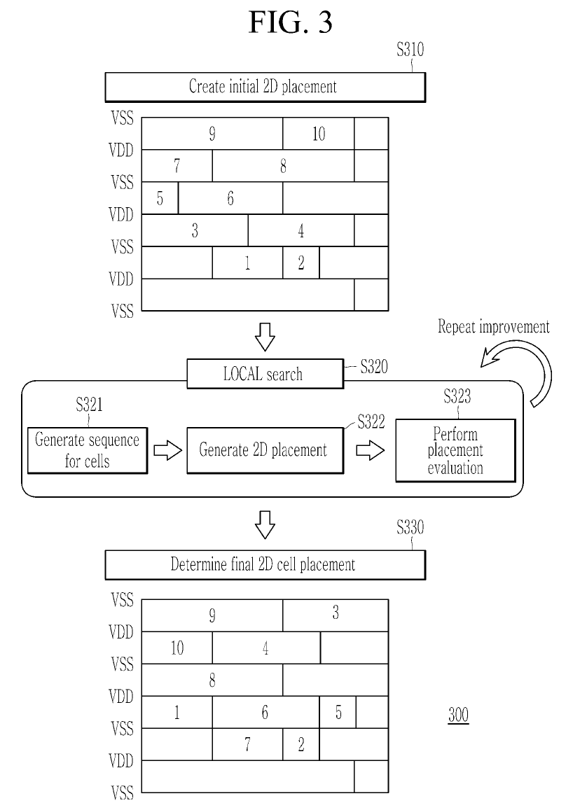

FIG. 3 illustrates an example process with two-dimensional cell placement optimization according to one or more embodiments.

Referring to FIG. 3, in a non-limiting example, an electronic apparatus (e.g., electronic apparatus 100) may perform a process 300 with two-dimensional cell placement optimization to generate a sequence for multiple cells, and may create an initial two-dimensional placement based on the sequence in step S310.

In an example, an electronic apparatus (e.g., electronic apparatus 100) may randomly generate a sequence, and may two-dimensionally place it to create an initial cell placement.

The electronic apparatus may express a circuit optimization problem in a two-dimensional placement form, and may define a structure.

The electronic apparatus may display a current state of a circuit as a sequence of cells.

The electronic apparatus may include information about a cell, such as a two-dimensional shape of the cell, positions of ports within the cell, and connection information between cells.

The electronic apparatus may group and manage specific cells that are movable together.

The electronic apparatus may indicate cell power information when indicating cell information, and may generate a cell sequence based on this.

That is, the electronic apparatus may consider power such as VDD and VSS when generating a cell sequence, and may generate flip information.

In an example, an electronic apparatus with two-dimensional cell placement optimization (e.g., electronic apparatus 100) may determine an optimized final two-dimensional cell placement by performing a local search algorithm from an initial cell placement in steps S320 to S330.

The electronic apparatus may perform electronic through a local search algorithm in step S320.

The electronic apparatus 100 may generate a sequence for cells using the local search algorithm in step S321.

Thereafter, in an example, an electronic apparatus (e.g., the electronic apparatus 100) may generate a two-dimensional placement based on the generated sequence in step S322.

Additionally, in an example, an electronic device (e.g., electronic device 100) may perform a placement evaluation on the generated two-dimensional placement in step S323. The placement evaluation may be performed based on measuring a wire length of a semiconductor circuit and whether the measured wire length is minimized.

The electronic apparatus may generate a sequence for cells, and may create a two-dimensional placement based on the sequence.

For example, the electronic apparatus may place cells from lower left to right in the generated sequence order. For example, the cells may be placed from left to right in a next row when one row is fully occupied.

The electronic apparatus may place cells from right to left in the next row from right to left based on relative superiority of placement lengths when one row is fully occupied.

The electronic apparatus may read cell information, areas where cells are placed, dummy area information, power information between upper and lower cells, and cell sequence information.

In addition, the electronic apparatus may manage power constraints such as VDD and VSS at top/bottom of cells according to the cell sequence when placing cells.

In an example, an electronic apparatus (e.g., electronic apparatus 100) may manage grouped cells to move as a group unit when certain cells are pre-determined to form a group. For example, the cells may be arranged for the cells to be placed to minimize idle space among feasible placements when shapes of connection portions between two consecutive cells differ.

The electronic apparatus may generate a two-dimensional placement considering a limited number of connections when routing congestion restricts the number of the connections. That is, the cells may be placed based on the cell sequence to ensure that legalization constraints are satisfied. For example, a two-dimensional cell placement optimization problem may be solved using a local search-based optimization algorithm.

In an example, an electronic apparatus (e.g., electronic apparatus 100) may perform a local search operation on cells expressed in a sequence form. For example, the local search may be performed by the electronic apparatus until a local optima is reached.

In an example, the electronic apparatus (e.g., electronic apparatus 100) may extract cells expressed in a sequence one by one to insert them into different positions. For example, the a partial sequence of a cell sequence may be extracted and reversed. In addition, two or more cells may be selected and their order changed. In another example, two consecutive cells may be extracted and inserted into different positions. However, the number of cells being extracted are not limited thereto and, for example, three consecutive cells may be extracted in order to insert them into different positions.

The electronic apparatus may identify feasible candidate sets of placements that satisfy constraints during the generation of two-dimensional placements, and may update the placement in a direction of a greatest increment based on placement evaluation.

The electronic apparatus may update cells to have an optimal flip shape after the local search operation is completed.

The local optima refers to a solution that is locally optimal (in an area) in an optimization problem. In other words, the local optima refers to a state where a solution is optimal within a specific local range, but there may exist a better solution in a global range.

In an example, the electronic apparatus (e.g., electronic apparatus 100) may use the following method to determine the local optima.

First, all solutions within the neighborhood of a current solution may be evaluated, and from these evaluations a local optima may be determined if a cost (i.e., an objective function value, e.g., placement evaluation result) of all the neighboring solutions is worse than that of the current solution. For example, the local optima may be determined as having been reached in the local search algorithm if the placement evaluation results no longer improve over a certain period of time.

The electronic apparatus may record the search history, and may check whether a current placement is similar to a previously generated optimal solution. If the same pattern repeats, the electronic apparatus may determine that the local optima has been reached.

The electronic apparatus may perform a perturbation operation to generate a new placement by changing a portion of the placement generated according to the final update when falling into the local optima due to continuous two-dimensional placement updates. A degree of perturbation may be directly managed by a user.

The perturbation algorithm may randomly perturb the current solution to generate a new solution in an optimization problem, such as a local search algorithm.

The electronic apparatus may generate a global optimum placement by deviating from a local optimum placement using the perturbation algorithm.

The electronic apparatus may design various objective functions and cost functions according to a purpose of a user, and may reflect feasibility of a placement.

In an example, an electronic apparatus with two-dimensional cell placement optimization (e.g., electronic apparatus 100) may determine a final two-dimensional cell placement based on optimization using a local search algorithm and a disturbance algorithm, achieving the highest placement evaluation result in step S330.

The electronic apparatus may form cells into a sequence according to a cell sequence generated based on a one-dimensional placement algorithm, generate a two-dimensional placement based on this, and perform a placement evaluation based on half parameter wire length (HPWL) for the generated two-dimensional placement.

The electronic apparatus may determine a final two-dimensional placement that minimizes the HPWL as a result of the placement evaluation. In this process, the sequence of each of the cells may be optimized through local search and perturbation. In this example, constraints required for two-dimensional placement may be considered in order to place two-dimensional cells based on the sequence.

FIG. 4 illustrates an example process with two-dimensional cell placement optimization according to one or more embodiments.

Referring to FIG. 4, in a non-limiting example, an example of local search-based sequence generation and two-dimensional placement generation is illustrated.

In particular, FIG. 4 illustrates a view for describing a two-dimensional placement optimization algorithm and a structure of interaction between a local search operation and a two-dimensional placement.

In an example, an initial sequence 41 is [1, 2, 3, 4, 5, 6, 7, 8, 9, 10]. An electronic apparatus with two-dimensional cell placement optimization (e.g., electronic apparatus 100) may move a position of [3, 4] cells to right of a 9^{th} cell through the local search operation. As a result, a sequence 42 generated through this process may be [1, 2, 5, 6, 7, 8, 9, 3, 4, 10].

The electronic apparatus may generate a two-dimensional placement 44 using the generated sequence 42, and may measure the HPWL, which is a circuit wire length indicator.

For example, an HPWL of a two-dimensional placement 43 based on the initial sequence 41 being 3524 is illustrated.

In addition, an HPWL of the two-dimensional placement 44 based on the sequence 42 generated through the electronic apparatus being 3472 is illustrated.

Accordingly, it may be observed that the wiring length is reduced compared to the original according to an optimization algorithm of the electronic apparatus.

The electronic apparatus may identify candidate placements feasible for local search in a current state, and may update a cell sequence in a direction that yields a most improved placement evaluation result among them.

The electronic apparatus may employ either a first improvement strategy or a max improvement strategy as an improvement approach to update to a better result during the local search.

For example, the first improvement strategy may immediately adopt and update a first alternative that is better than a current solution as a new current solution. On the other hand, the max improvement strategy may review all alternatives that can improve the current solution and then a final update may be performed.

The electronic apparatus may utilize the max improvement strategy while prioritizing final performance.

The electronic apparatus may iteratively perform the local search operation in this manner to improve and refine the solution. Then, when trapped in the local optima, it overcomes the situation by employing a perturbation strategy.

That is, the electronic apparatus may iteratively perform this local search-based optimization algorithm to ultimately generate a two-dimensional cell placement with a shortest wiring length.

FIG. 5 illustrates an example process with two-dimensional cell placement optimization according to one or more embodiments.

That is, FIG. 5 illustrates an example of a two-dimensional placement of cells in an actual circuit.

Referring to FIG. 5, in a non-limiting example, an electronic apparatus (e.g., electronic apparatus 100) with two-dimensional cell placement optimization may perform a process including generating a sequence for a circuit formed of 20 cells, creating a two-dimensional placement, and then performing a placement evaluation (i.e., evaluating a placement) (e.g., HPWL).

The electronic apparatus may undergo an optimization process using a local search algorithm and perturbation algorithm, as described above, to output final cell sequence and two-dimensional placement results.

The electronic apparatus may have to satisfy various constraints required for generating a two-dimensional placement for an actual circuit placement. For example, the 2D placements may be generated to satisfy a feasibility of the semiconductor circuit based on cell data for the cells. In an example, the 2D placements may be generated to satisfy predetermined constraints for the semiconductor circuit based on cell data regarding the placements of the cells.

The electronic apparatus may utilize various types of cells for creating a two-dimensional placement. In a case of a one-dimensional placement, circuits formed of basic rectangular cells may be arranged, whereas a problem of two-dimensional placement may require placement while considering various polygonal shapes.

The two dimensional placement may be determined in order to minimize idle space when placing cells to increase circuit utilization.

The electronic apparatus may perform a placement while maintaining placement restrictions of a dummy area.

The electronic apparatus may reflect a power constraint. That is, connected cells in a same power state at areas where power is connected may be placed vertically.

The electronic apparatus may also generate a two-dimensional placement by incorporating constraints required during circuit design. For example, cells may be arranged to satisfy a grouping function for specific cells that are clustered together.

The electronic apparatus may reflect flip information. Cells may be flipped vertically or horizontally, and as the flipped orientation alters positions of ports and power connections. That is, in an example, the may generate a placement for the cells to adopt appropriate flip configurations.

FIG. 6 illustrates an example electronic device according to one or more embodiments.

Referring to FIG. 6, in a non-limiting example, an electronic apparatus with two-dimensional cell placement optimization (e.g., electronic apparatus 100) and method (e.g., method 500) may be implemented using a electronic device 900.

The electronic device 900 may include at least one of a processor 910, a memory 930, a user interface input device 940, a user interface output device 950, and a storage device 960 which communicate each other via a bus 920. The electronic device 900 may also include a network interface 970 electrically connected to a network 90. The network interface 970 may transmit or receive signals to or from other elements through the network 90.

The processor 910 may be configured to execute programs or applications to configure the processor 910 to control the electronic device 900 to perform one or more or all operations and/or methods involving providing of positional encoding to a neural network. The processor 910 may be implemented in various types of computing devices, such as a micro controller unit (MCU), an application processor (AP), a central processing unit (CPU), a graphic processing unit (GPU), a neural processing unit (NPU), etc., and may be any semiconductor device that executes instructions stored in the memory 930 or the storage device 960. The processor 910 may be configured to implement the functions and methods described above with respect to FIGS. 1 to 5.

The memory 930 may include computer-readable instructions. The processor 910 may be configured to execute computer-readable instructions, such as those stored in the memory 930, and through execution of the computer-readable instructions, the processor 910 may be configured to perform one or more, or any combination, of the operations and/or methods described herein. The memory 930 and the storage device 960 may include various types of volatile or nonvolatile storage media. For example, the memory may include a read only memory (ROM) 931 and a random access memory (RAM) 932. In an example, the memory 930 may be positioned internally or externally to the processor 910, and the memory 930 may be connected to the processor 910 through a variety of known means.

In an example, at least some of the components or functions of the two-dimensional cell placement optimization apparatus and device according to the embodiments described below may be implemented as a program or software running on the electronic device 900, and the program or software may be stored on a computer-readable medium.

In an example, at least some components or functions of the two-dimensional cell placement optimization apparatus and device according to the embodiments may be implemented using hardware or circuitry of the electronic device 900, or may be implemented as separate hardware or circuitry that can be electrically connected to the electronic device 900.

.

What is claimed is:

1. An electronic apparatus, comprising:
one or more processors comprising processing circuitry; and
a memory comprising one or more storage media storing instructions that, when executed individually or collectively by the one or more processors, cause the electronic apparatus to:
generate multiple sequences for multiple cells of a semiconductor circuit;
generate multiple 2D placements for the multiple cells based on the generated sequences;
evaluate a placement for each of the multiple 2D placement; and
determine a final 2D placement among the 2D placements based on a result of the placement evaluation.

2. The apparatus of claim 1, wherein the generating of the multiple sequences comprises:
randomly generating the sequences without duplication.

3. The apparatus of claim 1, wherein the generating of the multiple sequences comprises:
sequentially generating the multiple sequences using a local search algorithm based on a result of the placement evaluation.

4. The apparatus of claim 3, wherein the generating of the multiple sequences further comprises:
generating the multiple sequences using a perturbation algorithm responsive to an occurrence of a local optima according to the local search algorithm.

5. The apparatus of claim 1, wherein the generating of the multiple 2D placements comprises:
generating a plurality of 2D placements to satisfy a feasibility of the semiconductor circuit based on cell data for the cells.

6. The apparatus of claim 5, wherein the generating of the multiple 2D placements comprises:
generating the 2D placements to satisfy predetermined constraints based on the cell data in relation to placements of the cells.

7. The apparatus of claim 6, wherein the cell data includes one or more of a two-dimensional shape of a cell, a position of a port within a cell, connection information of cells, power information of the cell, and flip information of the cell.

8. The apparatus of claim 7, wherein the generating of the multiple 2D placements comprises:
generating 2D placements to minimize idle space according to 2D shapes of the multiple cells responsive to a satisfaction of both the feasibility and the predetermined constraints.

9. The apparatus of claim 1, wherein the evaluating comprises:
measuring a wire length of the semiconductor circuit for the 2D placements; and
evaluating the placement based on the measured wire length.

10. The apparatus of claim 9, wherein the determining of the final 2D placement comprises:
determining at least one placement to minimize the wiring length among the 2D placements as a final 2D placement by using a local search algorithm and a perturbation algorithm.

11. A processor-implemented method, the method comprising:
generating multiple sequences for multiple cells of a semiconductor circuit;
generating multiple 2D placements for the multiple cells based on the generated sequences;
evaluating a placement for each of the multiple 2D placement; and
determining a final 2D placement among the 2D placements based on a result of the placement evaluation.

12. The method of claim 11, wherein the generating of the multiple sequences comprises:
randomly generating the multiple sequences without duplication.

13. The method of claim 11, wherein the generating of the multiple sequences comprises:
sequentially generating the multiple sequences using a local search algorithm based on a result of the placement evaluation.

14. The method of claim 13, wherein the generating of the multiple sequences comprises:
generating the multiple sequences using a perturbation algorithm responsive to an occurrence of a local optima according to the local search algorithm.

15. The method of claim 11, wherein the generating of the multiple 2D placements comprises:
generating a plurality of 2D placements to satisfy a feasibility of the semiconductor circuit based on cell data for the cells.

16. The method of claim 15, wherein the generating of the multiple 2D placements further comprises:
generating the 2D placements to satisfy predetermined constraints based on the cell data in relation to placements of the cells.

17. The method of claim 16, wherein the cell data includes one or more of a two-dimensional shape of a cell, a position of a port within a cell, connection information of cells, power information of the cell, and flip information of the cell.

18. The method of claim 17, wherein the generating of the multiple 2D placements further comprises:
generating 2D placements to minimize idle space according to 2D shapes of the multiple cells responsive to a satisfaction of both the feasibility and the predetermined constraints.

19. The method of claim 11, wherein the evaluating comprises:
measuring a wire length of the semiconductor circuit for the 2D placements; and
evaluating the placement based on the measured wire length.

20. The method of claim 19, wherein the determining of the final 2D placement comprises:
determining at least one placement to minimize the wiring length among the 2D placements as a final 2D placement by using a local search algorithm and a perturbation algorithm.
